(19) United States
(12) Patent Application Publication
(10) Pub. No.: US 2008/0040434 A1
(43) Pub. Date: Feb. 14, 2008

(54) METHOD FOR LOGGING ONTO A PLURALITY OF SERVERS THROUGH AN INSTANT MESSENGER

(76) Inventor: CHING-KANG LEE, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/735,446

(22) Filed: Apr. 14, 2007

Related U.S. Application Data
(60) Provisional application No. 60/822,081, filed on Aug. 11, 2006.

(51) Int. Cl. G06F 15/16

(52) U.S. Cl. 709/206

(57) ABSTRACT

A method for logging onto a plurality of servers through an instant messenger is disclosed. The method includes logging onto a first server through an instant messenger to create a link; and logging onto a second server through the instant messenger while the link is still active.

### CROSS REFERENCE TO RELATED APPLICATIONS

This application claims the benefit of U.S. Provisional Application No. 60/822,081, filed Aug. 11, 2006, which is included herein by reference.

### BACKGROUND OF THE INVENTION

1. Field of the Invention

The present invention relates to an instant messenger, and more particularly, to a method for logging onto a plurality of servers through an instant messenger.

2. Description of the Prior Art

Please refer to FIG. 1. FIG. 1 is a diagram illustrating a prior art instant messenger 100. As shown in FIG. 1, a user U1 uses the instant messenger 100 to log onto a server as a client C1.

Please refer to FIG. 2. FIG. 2 is a diagram illustrating a prior art instant messaging system 200. Users U1 to Un respectively use the instant messengers 100 to log onto a server S1 as clients C1 to Cn. In the server S1, if the user U1 has the user U2 in the contact list of the user U1, the users U1 and U2 can exchange instant messages through their respective instant messengers 100, and so do other users logged onto the same server S1. If the user U1 does not have the user U2 in the contact list of the user U1, the user U1 cannot send instant messages to the user U2, nor can the user U1 send instant messages to users not in the contact list of the user U1.

Please refer to FIG. 3. FIG. 3 is a diagram illustrating a user logged onto different servers. As shown in FIG. 3, a user U1 is logged onto different servers S1 and S2 respectively through the prior art instant messengers 100 and 310. The instant messengers 100 and 310 are custom designed for the servers S1 and S2 respectively so that the instant messenger 100 cannot be used to log onto the server S2 and the instant messenger 310 cannot be used to log onto the server S1. In order to log onto both servers S1 and S2, the user U1 has to install 2 different instant messengers 100 and 310 in the user U1's computer. After the user U1 uses the instant messenger 100 to log onto the server S1 as a client C1, he can only exchange instant messages with on-line clients registered in the server S1. After the user U1 uses the instant messenger 310 to log onto the server S2 as a client C2, he can only exchange instant messages with on-line clients registered in the server S2. Therefore, if a user wants to log onto more servers, he has to install more custom designed instant messengers to log onto the corresponding servers, which occupies a lot of computer resource and is not convenient for the user.

### SUMMARY OF THE INVENTION

The present invention provides an instant message system. The instant message system comprises a server system comprising a plurality of servers, each server being for providing instant message services for first hosts and first clients logged onto the server; and an instant messenger for linking at least two of the plurality of servers concurrently.

The present invention further provides a method for logging onto a plurality of servers through an instant messenger. The method comprises following steps: (a) logging onto a first server through an instant messenger to create a link; and (b) logging onto a second server through the instant messenger while the link is still active.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art instant messenger.

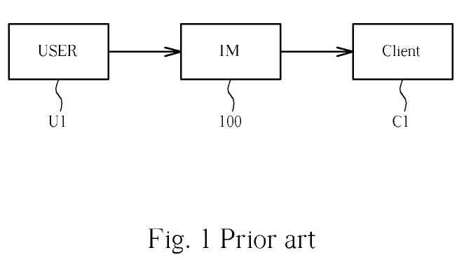

FIG. 2 is a diagram illustrating a prior art instant messaging system.

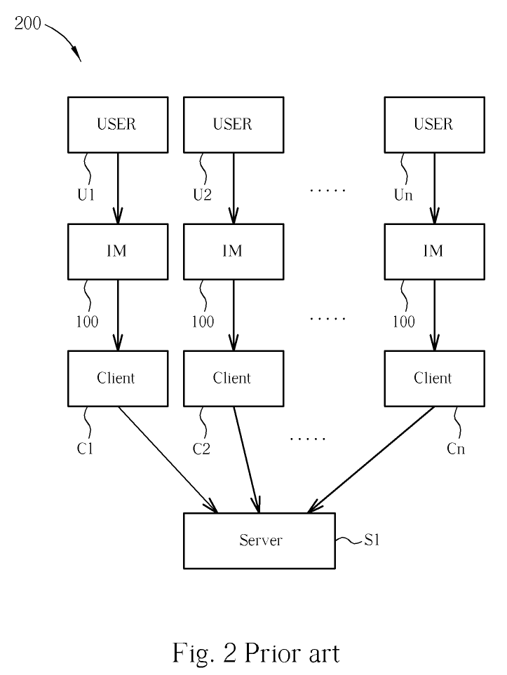

FIG. 3 is a diagram illustrating a user logged onto different servers according to the prior art.

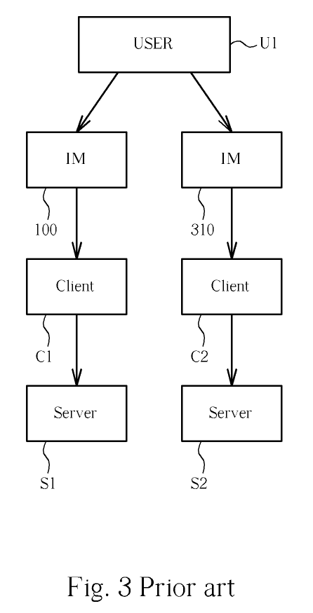

FIG. 4 is a diagram illustrating an instant messenger of a first embodiment of the present invention.

FIG. 5 is a diagram illustrating an instant messenger of a second embodiment of the present invention.

FIG. 6 is a diagram illustrating a user using the instant messenger of the present invention to log in a server as a host.

FIG. 7 is a diagram illustrating a user using the instant messenger of the present invention to log in a server as a client.

FIG. 8 is a diagram illustrating an instant messaging system of the present invention.

FIG. 9 is a flowchart illustrating a user using the instant messenger in FIG. 8 to log in a server.

FIG. 10 is a diagram illustrating the interface of the instant messenger in FIG. 8.

### DETAILED DESCRIPTION

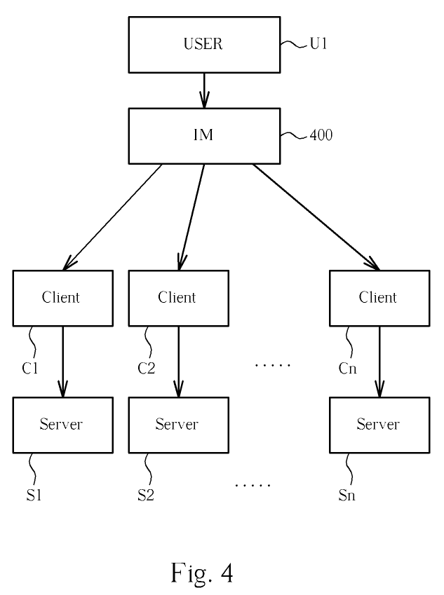

Please refer to FIG. 4. FIG. 4 is a diagram illustrating an instant messenger 400 of a first embodiment of the present invention. As shown in FIG. 4, when a user U1 logs onto the servers S1 to Sn respectively as clients C1 to Cn through only one instant messenger 400 of the present invention, the user U1 can communicate with on-line clients registered in the server S1 through the instant messenger 400. And the user U1 can communicate with on-line clients registered in the server S2 through the instant messenger 400, and so on. Consequently, the user U1 only has to install one instant messenger 400 and all the servers S1 to Sn can be logged on through the instant messenger 400.

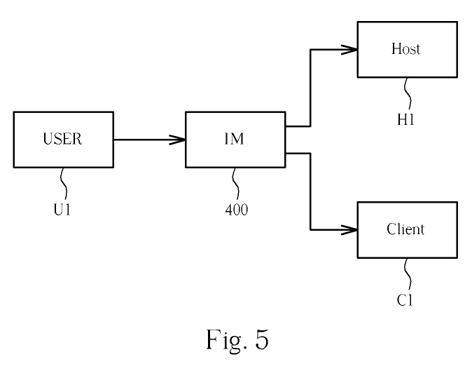

Please refer to FIG. 5. FIG. 5 is a diagram illustrating an instant messenger 400 of a second embodiment of the present invention. As shown in FIG. 5, a user U1 uses the instant messenger 400 to log onto a server as a host H1 or a client C1. A host can manage a server, manage the registrations and authorities of the clients registered in the server, and exchange instant messages with other on-line clients registered in the server. A client can only exchange instant messages with other on-line clients registered in the same server.

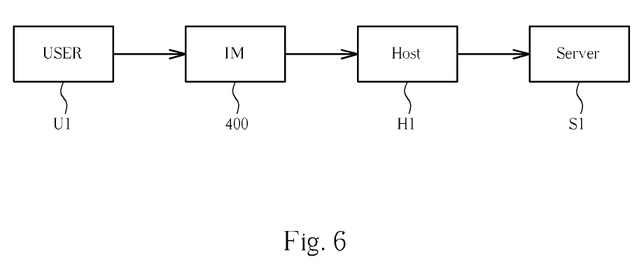

Please refer to FIG. 6. FIG. 6 is a diagram illustrating the user U1 using the instant messenger 400 of the present invention to log in a server S1 as a host H1. In this case, the user U1 can manage the server S1, manage the registrations and authorities of the clients registered in the server S1, and exchange instant messages with on-line clients registered in the server S1. One example of the user U1 managing the authority of a client is that the host H1 can establish a contact list for the client. When a client Cx logs onto the server S1, instead of allowing the client Cx to establish connections with all of the on-line clients registered in the server S1 on the server, just allow the client Cx to exchange instant messages to some of the on-line clients registered in the server S1.

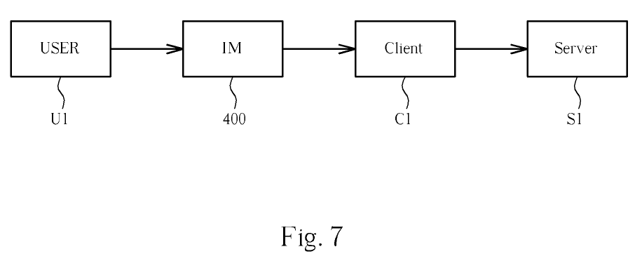

Please refer to FIG. 7. FIG. 7 is a diagram illustrating the user U1 using the instant messenger 400 of the present invention to log in the server S1 as a client C1. In this case, the user U1 can only exchange instant messages with on-line clients allowed by the host of the server S1.

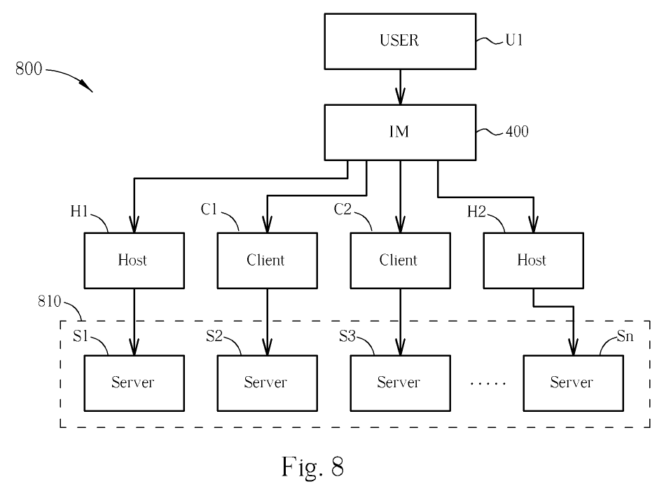

Please refer to FIG. 8. FIG. 8 is a diagram illustrating the instant messaging system 800 of the present invention. As shown in FIG. 8, the instant messaging system 800 includes a server system 810 and an instant messenger 400. The server system 810 includes a plurality of servers S1 to Sn. The servers S1 to Sn of the server system 810 can be independent from each other, or can be sub-servers of the server system 810 if the server system 810 is an internet data center (IDC). When the server system 810 is an IDC, the user can log onto a plurality of sub-servers by performing only one log in process to establish a connection with the IDC. Therefore it is very convenient for the user. Either the servers S1 to Sn are independent from each other or are sub-servers of the IDC, the clients on a server can only communicate with other on-line clients registered in the same server. If the user wants to communicate with clients registered in another server, he has to log into another server for communicating with the clients on that server.

Please refer to FIG. 8 again. As shown in FIG. 8, the user U1 can use the instant messenger 400 to log in several servers S1, S2, S3, and Sn. Using the instant messenger 400, the user can log in a plurality of servers with a plurality of accounts. For example, the user U1 can use the instant messenger 400 to log in the server S1 as a host H1, in the server S2 as a client C1, in the server S3 as a client C2, and in the server Sn as a host H2 at the same time. In this case, the user U1 can communicate with the on-line clients registered in the servers S1, S2, S3 and Sn, and can manage the servers S1 and Sn.

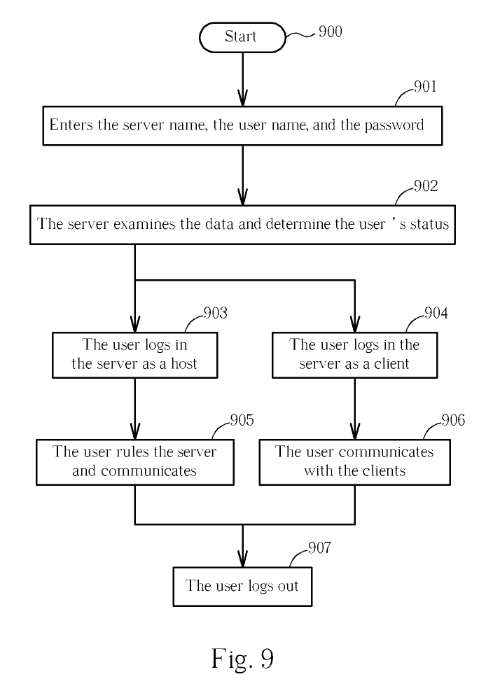

Please refer to FIG. 9. FIG. 9 is a flowchart illustrating a user U1 using the instant messenger 400 to log in a server and related details. The steps are described as follows:

Step 900: Start;

Step 901: The user U1 enters the server name, the user name, and the password for logging in the server;

Step 902: The server examines the data the user U1 enters, and determines the user's status accordingly; if the server determines the user U1 to be a host, go to step 903; if the server determines the user U1 to a client, go to step 904;

Step 903: The user U1 logs in the server as a host;

Step 904: The user U1 logs in the server as a client;

Step 905: The user U1 manages the server and communicates with the clients on the server with the host account, then go to step 907;

Step 906: The user U1 communicates with the clients on the server with the client account;

Step 907: The user U1 logs out from the server.

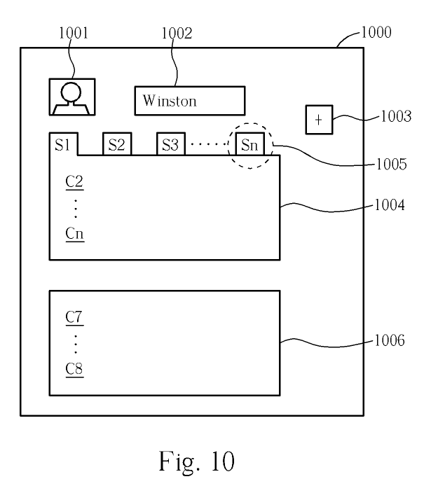

Please refer to FIG. 10. FIG. 10 is a diagram illustrating an interface 1000 of the instant messenger 400 of the present invention. The interface 1000 comprises a user's picture block 1001, a personal information block 1002, an adding-in icon 1003, a contact list 1004, a plurality of server tabs 1005, and a favorite contact block 1006. The user's picture block 1001 displays the user's personal picture. The personal information block 1002 provides the user's personal information such as his phone number, email address, etc. The adding-in icon 1003 is clicked when the user wants to log into an server which is not logged on yet. The contact list block 1004 provides a list of clients registered in a server. As shown in FIG. 10, the contact list block 1004 lists clients registered in the server S1 with on-line clients displayed in a first style and off-line clients displayed in a second style. Each logged on server is associated with a server tab 1005. Thus the user can switch to another contact list block 1004 corresponding to another logged-on server by clicking its corresponding server tab 1005. For example, when the user clicks the server tab labeled S3, the contact list block 1004 corresponding to the server S3 will be displayed to replace the contact list block 1004 corresponding to the server S1. The favorite contact block 1006 provides the user a space to display his favorite contacts. Therefore the favorite contact block 1006 can list clients registered in different servers. And the user can establish a connection with a client who is registered in a server whose contact list block 1004 is not currently displayed by clicking on the client in the favorite contact block 1006 without clicking on the corresponding server's tab to replace the currently displayed contact list block 1004. Additionally, when the user logs in another server by clicking on the adding-in icon 1003, a new server tab is generated for the newly logged-on server. Thus, if the user only logs in one server, only one server tab is displayed. If the user logs in 10 servers, 10 server tabs are displayed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An instant message system comprising:
a server system comprising:
a plurality of servers, each server being for providing instant message services for first hosts and first clients logged onto the server; and
an instant messenger for linking at least two of the plurality of servers concurrently.

2. The instant message system of claim 1 wherein the servers are isolated from each other.

3. The instant message system of claim 1 wherein the servers are sub-servers coupled to an internet data center (IDC).

4. A method for logging onto a plurality of servers through an instant messenger comprising following steps:
(a) logging onto a first server through an instant messenger to create a link; and
(b) logging onto a second server through the instant messenger while the link is still active.

5. The method of claim 4 wherein step (a) is a client logging onto the first server through the instant messenger to create the link; and step (b) is the client logging onto the second server through the instant messenger while the link is still active.

6. The method of claim 2 wherein step (a) is a host logging onto the first server through the instant messenger to create the link; and step (b) is the host logging onto the second server through the instant messenger while the link is still active.

7. The method of claim 4 further comprising building up a contact list from clients and hosts of the first server.

8. The method of claim 4 further comprising building up a contact list from clients and hosts of the second server.

9. The method of claim 4 further comprising displaying a user interface, the user interface comprising:
a picture block for displaying a stored picture;
a personal information block for displaying personal information;
an adding-in icon for adding servers to a plurality of servers which can be logged-on;
a plurality of server tabs; and
a contact list corresponding to a selected server tab.

10. The method of claim 9 wherein the user interface further comprises a favorite contact block.
